(19) United States
(12) Patent Application Publication
(10) Pub. No.: US 2012/0041581 A1
(43) Pub. Date: Feb. 16, 2012

(54) Magnetically connected multiple user earphone system

(76) Inventor: Vincent J. Lee, Cerritos, CA (US)

(21) Appl. No.: 13/136,343

(22) Filed: Aug. 1, 2011

Related U.S. Application Data
(60) Provisional application No. 61/400,527, filed on Jul. 30, 2010.

(51) Int. Cl. G06F 17/00

(52) U.S. Cl. 700/94

(57) ABSTRACT

An earphone system for connection of a plurality of earplugs to a common audio source for simultaneously sharing of music; the system providing connect and disconnect of the earplugs by means of magnetized connectors. The connectors include identical dual connector members providing passage of signals through the connector and have signal take-off points for sending signals to an associated set of earplugs. Subsequent dual connector members can be sequentially coupled to simultaneously provide the source signals to a plurality of earplugs. The ends of the dual connector members have a circular configuration assuring that a proper signal connection is established by any mating arrangement of the connectors.

### CLAIM FOR BENEFIT OF EARLIER FILING DATE

This application claims benefit of U.S. Provisional Application No. 61/400,527 filed on Jul. 30, 2010. The applications have the same inventor, title, and subject matter.

### BACKGROUND

The background of the invention will be discussed in two parts.

### FIELD OF THE INVENTION

The invention relates to earphone systems, and more particularly, to a system providing for simultaneously sharing of audio from a common source by multiple users.

### DESCRIPTION OF THE PRIOR ART

A considerable number of electrical connector assemblies for audio cables are found in the marketplace, each generally optimized for a particular use and having particular characteristics. U.S. Pat. No. 7,354,315, issued to Goetz, et al. on 8 Apr. 2008, relates to releasable connectors for portable media players such as an MP3. However, a search of the prior art has not disclosed a multiple user earphone system allowing for a plurality of earplugs to be connected to a common audio source for simultaneously sharing of audio signals such as music or the like emanating from the common source. Accordingly, it is an aspect of the present invention to provide a multiple user earphone system allowing for simultaneously sharing of audio signals such as music, or the like, emanating from a common source.

### SUMMARY

An earphone system for connection of a plurality of earplugs to a common audio source for simultaneously sharing of signals, the system providing convenient connect and disconnect of the earplugs by magnetized connectors. The magnetized connectors include dual identical connector members having means for passage of signals through the connector with signal take-off points for providing signals to an associated earplugs. Subsequent connectors can be sequentially magnetically coupled to simultaneously provide the source signals to a plurality of earplugs. The connector members have generally circular magnetized, generally planar, faces assuring a proper signal connection by any mating arrangement of the connectors. Optimum coupling and break-away characteristics are determined by selecting the connector strength of the magnetic forces

### DRAWINGS

FIG. 1 shows a multiple user earphone system in accordance with the invention;

FIG. 2 is an exploded view showing the magnetized connector of the system;

FIG. 3 is a cross-section view of the assembled magnetized connector;

FIG. 4 is an end view of the assembled magnetized connector;

FIG. 5 is an alternate embodiment of the signal A conductive spring;

FIG. 6 is a an alternate embodiment of the signal B conductive spring;

FIG. 7 shows a notched support panel for the alternate springs of FIGS. 5 and 6;

FIG. 8 is a cross-section view of the connector 13 of FIG. 1;

FIG. 9 is an exploded view of another embodiment of the invention;

FIG. 10 is a cross-section view of the connector of FIG. 9;

FIG. 11 shows circuit board 38 of the magnetized connector of FIG. 9; and

FIG. 12 shows circuit board 39 of the magnetized connector of FIG. 9.

### LIST OF REFERENCE NUMERALS

The following are reference numerals for like elements in the several views.
10. Multiple user earphone system with magnetized connectors
11. Common signal source
12. Jack to common signal source
12a Cable connecting jack 12 to magnetized connector 13
13. Magnetized connector for signal from common source 11
14. Magnetized connector for earphones
14a. Magnetized ends of earphone connector
14b. Earphone signal take off portion of magnetic connector 14
14c. Signal cable connecting signal take off earphone connector
14d. Splitter for direction of signals to earphones
14e Connector for engaging cable 14c to connector 14
15. Earphones
15a Slider for adjusting length of earphone leads
20a. Top cap of housing for magnetized connector 14
20b. Bottom cap of housing for magnetized connector 14
20c. Housing entry portion of top cap 20a for earphone take-off leads
20d Housing entry portion of bottom cap 20b for earphone take-off leads
21. Magnet housing
21a. Circular grounding connections C, D
22. Circular magnet
23. Circular insulator
24. Signal B conductor ring
24a. Ridge on signal B conductor ring
25. Signal B conductive spring for urging ridge 24a against insulator 23
26. Housing insulator 26
27. Signal A contact ball for fitting into housing insulator 26
28. Signal A spring urging ball 27 against a ridge in housing insulator 26
29. Circuit board
30. Connector 30
30a Top cap of housing for magnetized connector 30
30b Bottom cap of housing for magnetized connector 30
30c. Housing entry of top cap portion 30a for earphone take-off leads
30d. Housing entry of bottom cap portion 30b for earphone take-off leads
31. Magnet housing
32. Magnet
33. Insulator
36. Insulator
38. Circuit board
39. Circuit board
40. Alternate spring 40
50. Alternate spring 50
60. Mounting base for supporting springs 40 and 50.

### DESCRIPTION

The invention provides a system for connection of a plurality of earplugs to a common audio signal source, such as an MP3, for sharing of music. The system has magnetized connector members for easy connect/disconnect of sets of earplugs. It includes a cable having a jack on one end for connection to the signal source and a magnetized connector on the other end for mating to a first end of a dual member magnetized connector. The connector is configured to pass the source signals from one end to the other and includes take-offs points for providing the signals to an associated earplug set. Additional connectors can be sequentially coupled to provide the source signals to a plurality of earplugs. The dual end magnetized connectors are identical and thus reversible, the ends being of a circular design with a generally planar face assuring proper signal connection by any mating arrangement of the connectors. Optimum coupling and break-away characteristics are provided by selection of the strength of the magnets.

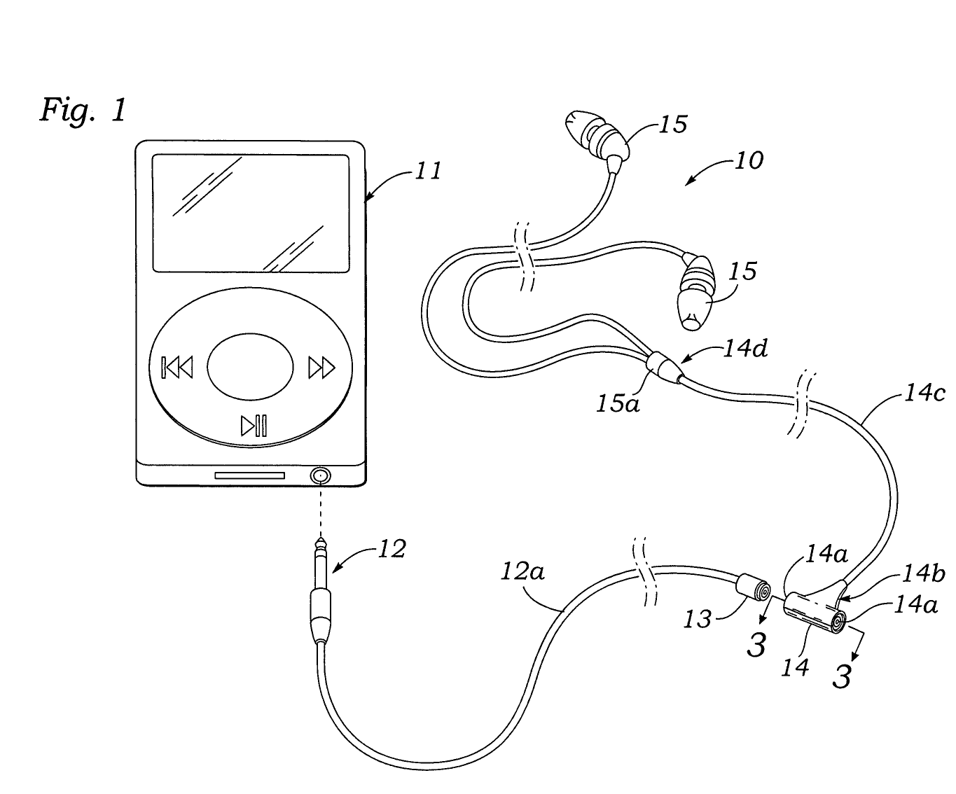

FIG. 1 illustrates the multiple user earphone system, generally designated 10, of the invention. The system 10 includes common signal source 11, and cable 12a having jack 12 and magnetized output connector end 13, for connecting the signal from source 11 to a first end 14a of connector 14. Connector end 13 and identical ends 14a are magnetized for easy connect/disconnect. Connector 14 additionally includes an earplug signal takeoff portion, generally designated 14b. Signal cable 14c is connected to takeoff portion 14b to send signals from source 11 to earplugs 15 by means of connector 14d. Additional connectors 14 may be sequentially coupled to provide simultaneous sharing of music to a plurality of earplug sets.

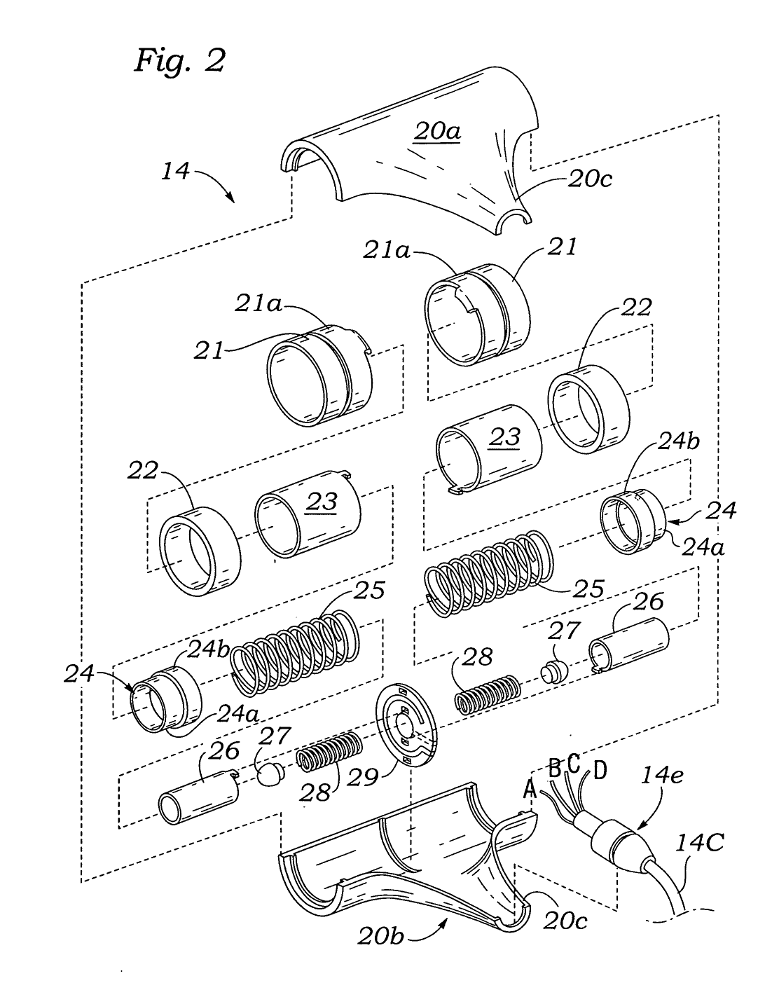

FIG. 2 is an exploded view of the components of the connector 14 of FIG. 1. Connector 14 includes a housing having a top cap portion 20a and a bottom cap portion 20b. Mating of portions 20a, 20b provides a housing for dual ends 14a and an earplug signal takeoff portion generally designated 20c. The magnetized connectors 14 include identical members connected back-to-back through circuit board 29. Signals may be received by either member and passed to the other member for further transmission, and as well provides contacts for signal take-off for earplugs 15.

The components of the dual members of connector 14 being identical, only the components of one member will be described. As indicated in FIG. 2, circular magnet housing 21 abuts closed caps 20a, 20b and receives circular magnet 22, housing 21 having circular portion 21a for grounding to leads C and D. Magnet 22 receives circular insulator 23 which in turn receives a portion 24a of circular signal B conductive ring 24. Conductive ring 24 further includes ridge 24b, which has a larger diameter than portion 24a, for receiving a portion of signal B conductive spring 25, spring 25 urging signal B conductive ring 24 against insulator 23. Conductive spring 25 is in contact with the circuit board 29 to thereby provide a signal B connection to earplug 15 by means of lead B of cable 14c. Through spring 25 conductive ring 24 receives insulator 26 which in turn receives signal A ball contact 27. Signal A ball contact 27 is urged against a ridge in insulator 26 by signal A spring 28, spring 28 in contact with the circuit board 29 to thereby provide a signal A connection to earphone 15 by means of lead A of cable 14c.

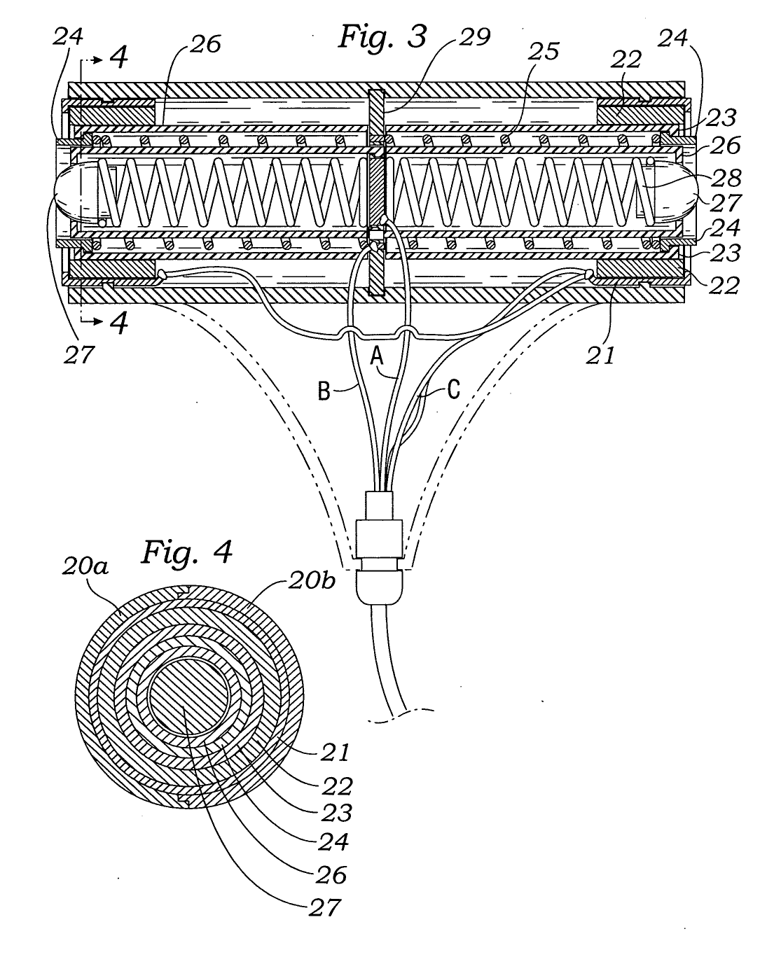

FIG. 3 illustrates in cross-sectional view the assembly of the components of the earplug system connector 14 of FIG. 2. As indicated in FIG. 2 and shown more clearly in FIG. 3, the source signals A and B may be received by either of the dual end magnetized connector members of connector 14 and passed through connector 14 to the other member for further transmission. For instance, when signal A is received by the ball 27 of a first member it is conducted through the associated spring 28 to circuit board 29 where it is picked off by the spring 28 on the other side of the circuit board and transmitted to the ball 27 of the second member. Likewise, when signal B is received by the circular connector 24 of the first member it is conducted through the associated spring 25 to circuit board 29 where it is picked off by the spring 25 on the other side of the circuit board and transmitted to the circular connector 24 of the second member. As shown, signal leads A and B and ground leads C and D are picked off of circuit board 29 and transmitted by cable 14C to earplugs 15c.

FIG. 4 is an end view of the planar face of the assembled magnetized connector 14 illustrating the concentric configuration of the components that provides for proper signal connection regardless of the mating arrangement of the connectors.

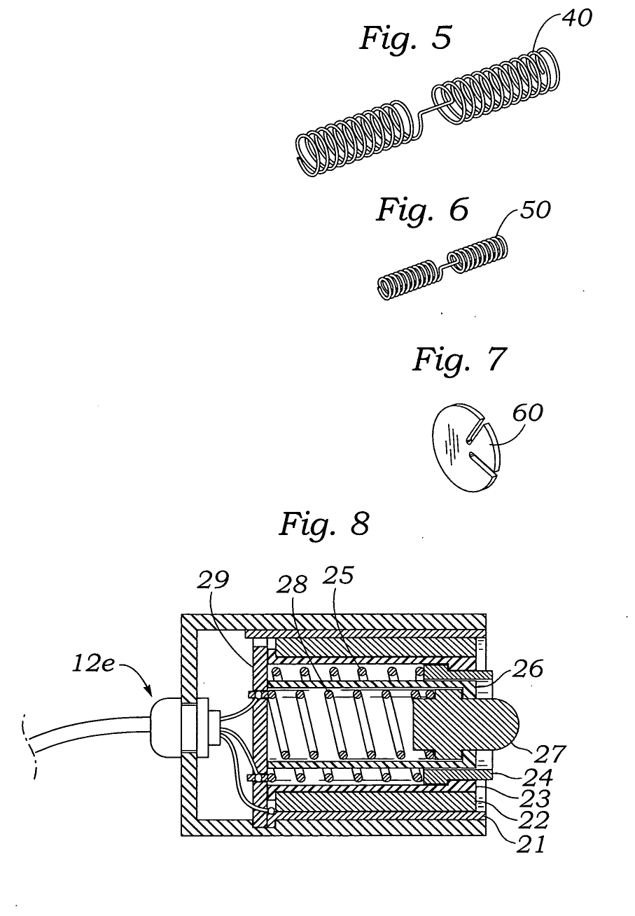

FIGS. 5-6 illustrate an alternate configuration where circuit board 29 is not used, FIG. 5 showing an alternate embodiment of the signal A conductive springs 25 wherein the springs 25 are connected to each other directly to form a single spring, FIG. 6 showing an alternate embodiment of the signal B conductive springs 28 wherein the springs 28 are connected to each other directly to form a single spring, and FIG. 7 showing a notched support panel for use with the alternate springs of FIGS. 5 and 6.

FIG. 8 is a cross-section view of the connector 13 of FIG. 1. It is seen that the connector 13 is essentially the same as one of the dual members of connector 14 as previously described and thus will not be further described.

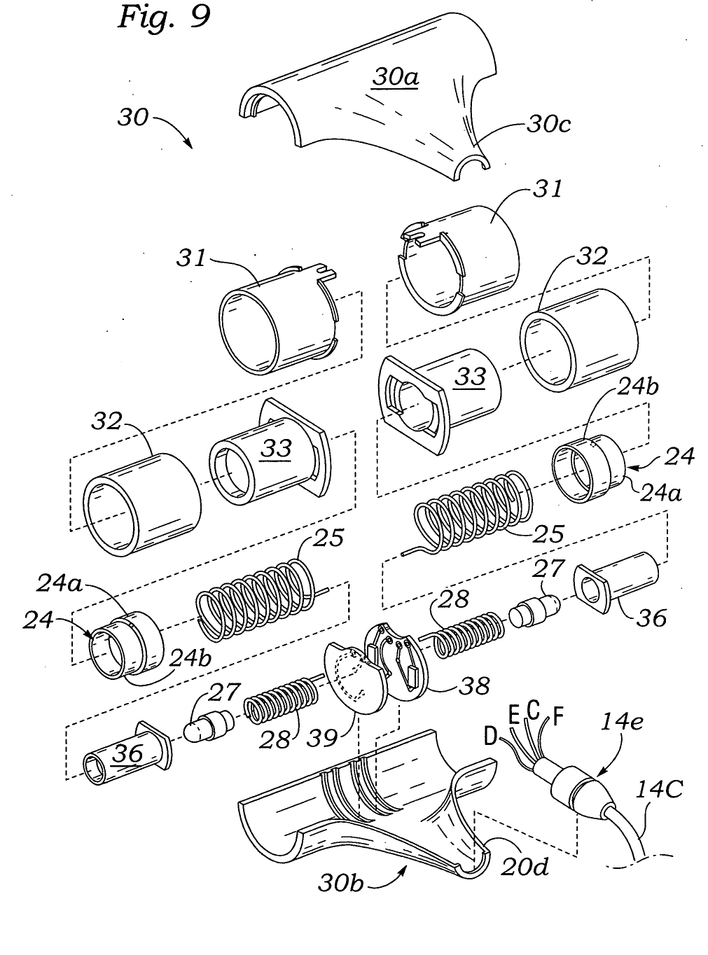

FIG. 9 is an exploded view of an embodiment of the invention wherein connector 30 is the same as connector 14 except for the modification to include two circuit boards 38, 39 instead of the single circuit board 29 of connector 14. Since the components of the dual members of connector 30 are identical, only the components of one member will be described. As shown in FIG. 9, circular magnet housing 31 abuts closed caps 30a, 30b and receives magnet 32, housing 31 having grounding leads C and D. Magnet 32 receives circular insulator 33 which in turn receives a portion 24a of the signal B conductive ring 24. Ring 24 includes ridge 24b which has a larger diameter than portion 24a for receiving a portion of signal B conductive spring 25, spring 25 urging signal B conductive ring 24 against insulator 33. Spring 25 is in contact with circuit board 38 to thereby connect signal B to earplug 15 by means of lead B of cable 14c. Spring 25 receives insulator 36 which receives signal A ball contact 27. Ball contact 27 is urged against insulator 36 by signal A spring 28, spring 28 in contact with the circuit board 38 to provide a signal A connection to earphone 15 by means of lead A of cable 14c.

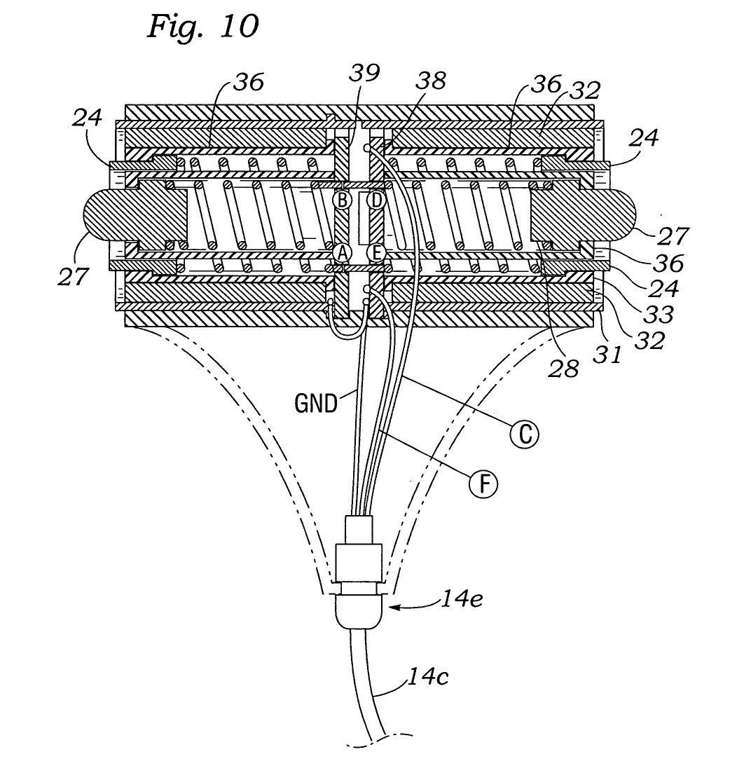

FIG. 10 shows in cross-sectional view the assembly of the components of the connector 30 of FIG. 9. As seen in FIGS. 9 and 10, source signals A and B can be received by either end of magnetized connector 30 and passed on to the other end for further transmission. Thus, when signal A is received by the ball 27 of the member abutting circuit board 38 it is conducted through associated spring 28 to circuit board 38 where it is forwarded to circuit board 39 where it is picked off by the spring 28 associated with circuit board 38 and transmitted to its associated ball 27. Likewise, when signal B is received by the circular connector ring 24 of the member abutting circuit board 38 it is conducted to circuit board 39 where it is picked off by associated spring 25 and transmitted to the connector ring 24 associated with circuit board 39. Circuit boards 38, 39 are separated by insulating spacers.

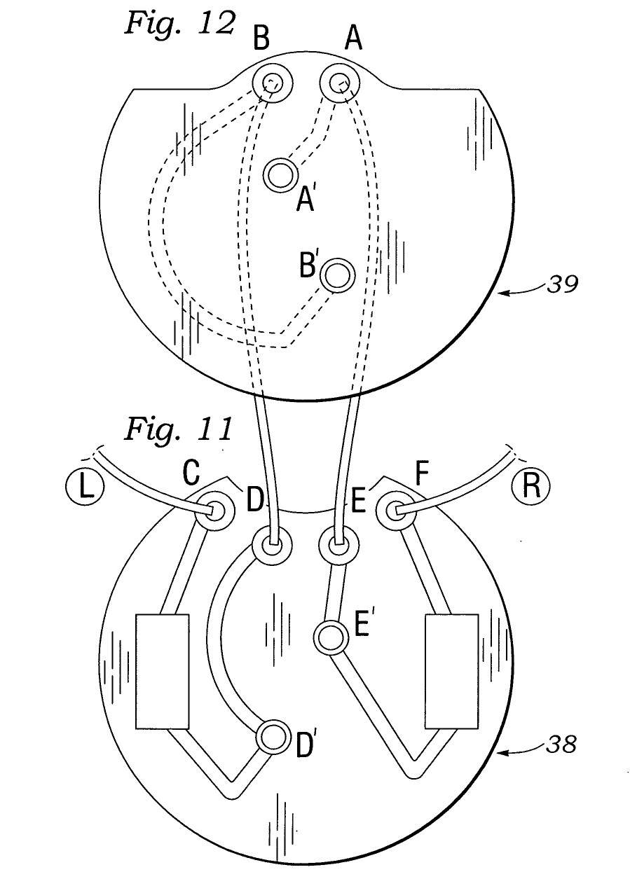

FIGS. 11 and 12 illustrate circuit boards 38 and 39 of the connector 30 of FIG. 9. Contacts D and E of board 38 are connected to signal contacts B and A respectively for sending signals A and B to board 39. Contacts C and F transmit signals A and B through cable 14c to earplugs 15. Contacts B′ and A′ of board 39 are signal contacts for associated spring 25. Contacts D′ and E′ of board 38 are signal contacts for associated spring 25.

The earplug connector system of the invention has been shown to include connectors having dual identical members, the connectors providing for passage of the source signal from one end to the other and include signal take-off points for providing the signal to associated earplugs. Subsequent connectors can be sequentially coupled to provide the source signal to a plurality of earplugs. The connectors are identical, reversible and interchangeable, and thus may be randomly connected to simultaneously share the signal from the common source. The connector ends are circular such that proper signal connection is established by any mating arrangement of the connectors. The magnetization of the connector ends is designed to provide easy and quick connection and disconnection of the connectors.

Although the invention is illustrated and described with reference to specific embodiments, it is to be understood that various changes may be made in adapting the invention to different embodiments without departing from the inventive concepts disclosed herein. Thus, the invention should not be limited to the embodiments as shown and described.

What is claimed is:

1. A multiple user earphone system for a media player comprising:
a media player;
at least one dual end connector;
at least one set of earplugs a first cable having on one end a jack for coupling to said media player and on the other end a first connector member for engagement with a first dual end connector, said connector member and said dual end connector having co-acting magnetized mating surfaces providing for break-away engagement; and
each of said dual end connectors configured for pass-through of output from said media player from a first end to a second end, and including take-off contacts for providing said media player output to said earplugs.

2. The system of claim 1 whereby additional dual end connectors with associated earplugs are sequentially magnetically mated for break-away engagement and to provide for mutual sharing of output from said media player by a plurality of users.

3. The system of claim 2 wherein said the end of said first connector member and the ends of each of said dual end connectors have circular planar faces with concentrically arranged magnets and signal contacts that provide for proper signal connection regardless of the mating orientation of either said first connector member or of said dual end connectors.

4. The system of claim 3 wherein said dual end connectors are substantially identical and each of said dual end connectors include:
first and second identical connector members interfaced for pass-through of said output from said media player; and
take-off contacts at said interface for providing said media player output to said earplugs.

5. The system of claim 4 wherein said first and second connector members are connected back to back on opposite sides of said interface.

6. The system of claim 5 wherein said first and second connector members each include:
at least one circuit board;
a circular magnet housing receiving a circular magnet and having means for grounding signal leads;
said circular magnet receiving a first circular insulator;
said first circular insulator receiving a portion of a circular first signal conductive ring;
said first signal conductive ring including means for receiving a first signal conductive spring, said first spring urging said first signal conductive ring against said first insulator and in contact with said first signal conductive ring and said circuit board to provide a first signal connection to said circuit board;
said first signal conductive ring receiving a second insulator;
said second insulator receives a second signal contact and a second conductive spring, said second conductive spring in contact with said circuit board and urging said second signal contact through said second insulator to partially emerge from said second insulator; and
said circuit board having first and second signal pick-off contacts for said earplugs.

7. A multiple user earphone system for a media player comprising:
a media player providing an output signal;
at least one set of earplugs;
an audio cable having a plug end and a contact end, said plug end configured to couple to said media player and said contact end having a magnetically releasable coupling member;
said coupling member having a circular planar mating face with concentrically arranged magnetic coupler and signal contacts;
at least one dual end connector with each end having a mating face identical to the mating face of said coupling member;
the magnetic mating of said cable coupling member and one end of a dual end connector forms a signal conducting path between said media player and said one end of said dual end connector;
said dual end connector configured to form a signal conducting path between said one end of said dual end connector and the other end; and
each said dual end connectors including take-off contacts for providing said media player output to said earplugs.

8. The system of claim 7 wherein said magnetically releasable coupling member provides coupling and break-away characteristics to each of said cable coupling mating face and said dual end connector faces.

9. The system of claim 8 wherein said connector members each include:
at least one circuit board;
a magnet housing receiving a magnet and having means for grounding signal leads;
said magnet receiving a first insulator;
said first insulator receiving a portion of a first signal conductive member;
said first signal conductive member including means for receiving a first signal conductive spring, said first spring urging said first signal conductive member against said first insulator and in contact with said first signal conductive member and said circuit board to provide a first signal connection to said circuit board;
said first signal conductive member receiving a second insulator;
said second insulator receives a second signal contact and a second conductive spring, said second conductive spring in contact with said circuit board and urging said second signal contact through said second insulator to partially emerge from said second insulator; and
said circuit board having first and second signal pick-off contacts for said earplugs.
